(19) United States
(12) Patent Application Publication
(10) Pub. No.: US 2026/0315640 A1
(43) Pub. Date: Oct. 15, 2026

(54) MULTI-UNIVERSAL AUTOMATION AND DIFFUSION MODULE WITH QUICK-REPLACEABLE SHELL

(71) Applicant: Majestic-M&A International Co., Ltd., TAIPEI (TW)

(72) Inventor: HSUAN-YU CHAO, TAIPEI (TW)

(21) Appl. No.: 19/175,930

(22) Filed: Apr. 10, 2025

(51) Int. Cl. A61L 9/14

(52) U.S. Cl. CPC A61L 9/14; A61L 2209/133; A61L 2209/134

(57) ABSTRACT

The present disclosure relates to a multi-universal automation and diffusion module with quick-replaceable shell, including a styling shell, a base configured with at least a circuit board, a motor pump and a rechargeable battery, and a spray assembly composed of an atomization and diffusion head, an assembling bottle and a bottom sleeve, which are connected with each other. A movable coupling mechanism is arranged between the bottom sleeve and the base, so as to mutually align with each other. Moreover, a plurality of bottle adapters are arranged under the atomization and diffusion module, which allow for the replacement and connection of the assembling bottles of different sizes. The overall effective design not only allows for quick replacement of the outer shell, but also simplifies the process of changing essential oils, and it also has further expanded compatibility.

### FIELD OF THE INVENTION

The present disclosure relates to the technical field of air purification and aroma diffuser, more particularly, to a multi-universal automation and diffusion module with quick-replaceable shell.

### BACKGROUND OF THE INVENTION

In recent years, the medical and beauty industries have developed rapidly, with people placing increasing importance on beauty care and medical wellness. The industry has been actively researching and designing various structures for aroma diffusers to atomize plant-based aromatic liquids, making them easier for human body to inhale and thereby facilitating aromatherapy.

A commonly known type of aroma diffuser primarily includes a base with an internal air supply motor pump. A diffuser bottle is connected to the base, and contains a specialized air nozzle and a corresponding straw. When the motor pump is activated to supply air, the essential oil is drawn up and atomized by a siphon mechanism.

In earlier designs, most diffuser bottles have an opened outlet at the top. The essential oil leakage may occur easily if the diffuser bottle is accidentally knocked over. Additionally, the overall shock resistance and soundproofing effects are poor.

As shown in FIG. 10, a multi-universal automation and diffusion module, including a main unit having a motor pump configured on one side and an internal chamber configured on the other side which allows a spray assembly to move in and out. Such that, the spray assembly may insert from the top to assemble effectively. The motor pump is controlled via a circuit board to drive the spray assembly to provide the effect of different spray output modes. The spray assembly can be conveniently pressed to remove and replace the essential oil bottle. Additionally, it offers advantages such as preventing a spill and leakage, reducing vibration when operating, and low-noise.

Because the internal layout of the improved structure of the new air pump diffuser adopts a horizontal parallel design, the appearance is relatively low but actually occupies a larger area. In addition, the overall structure is complex, and the manufacturing and assembly are more challenging. The product also lacks design versatility, and the external casing cannot be easily and flexibly replaced. In addition, the spray assembly can only be compatible with a 18mm-diameter essential oil bottle available on the market and cannot widely accommodate other perfume bottles having different diameters, such as 20 mm or 24 mm.

### SUMMARY OF THE INVENTION

In view of this, the main purpose of the present disclosure is to provide a multi-universal automation and diffusion module, including a styling shell, a base and a spray assembly.

The styling shell is in the shape of a hollow cylinder, with coupling holes and respectively configured on a top and a bottom of the styling shell, and a window is configured on the styling shell.

The base is configured to assemble with the coupling hole located at the bottom of the styling shell. The base is configured with at least a circuit board, a motor pump and a rechargeable battery, which connect to a control panel disposed in the window.

The spray assembly is composed of an atomization and diffusion head, an assembling bottle and a bottom sleeve, which are connected with each other, wherein a movable coupling mechanism is arranged between the bottom sleeve and the base, so as to mutually align with each other.

An internal thread port is configured at a bottom of the atomization and diffusion head, allowing for replacing and assembling with a plurality of bottle mouth adapters. Each bottle adapter has an external thread port configured at a top with a corresponding same diameter and an internal thread port with a different diameter is arranged at a bottom, so as to be connected with the assembling bottles having different sizes and specifications. The assembling bottle comprises essential oil bottles and perfume bottles, but the present disclosure is not limited thereto.

Compared with the existing technology, the advantages of the multi-universal atomization and diffusion module with quick-replaceable shell lie in that the overall structural design is simple and practical. Not only can the shell be quickly replaced, but the process of replacing essential oils is also simplified. It also has expanded compatibility. In addition to the commonly used essential oil bottles, it can also widely accommodate perfume bottles with various specifications available on the market, thereby effectively improving the flexibility and convenience of use, while fully meeting consumers' demand for personalized and diversified products.

### BRIEF DESCRIPTION OF THE DRAWINGS

FIG. 1 is a three-dimensional exploded view of the present disclosure.

FIG. 2 is a schematic diagram of the bottle mouth adapter of the present disclosure.

FIG. 3 is a three-dimensional exploded view of the spray assembly of the present disclosure.

FIG. 4 is a diagram illustrating an embodiment of quick-replaceable shell of the present disclosure.

FIG. 5 is a three-dimensional exploded view of the spray assembly of another embodiment of the present disclosure.

FIG. 6 is a diagram illustrating another embodiment of quick-replaceable shell of the present disclosure.

FIG. 7 is a three-dimensional exploded view of the atomization and diffusion head of the present disclosure.

FIG. 8 is a cross-sectional view of the spray assembly of the present disclosure.

FIG. 9 is a cross-sectional view of another atomizing and diffusing head of the present disclosure.

FIG. 10 is a cross-sectional view of the structural combination in the prior art.

### DETAILED DESCRIPTION OF THE INVENTION

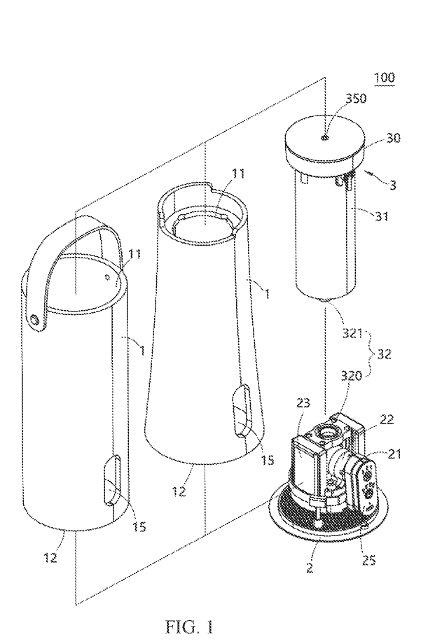

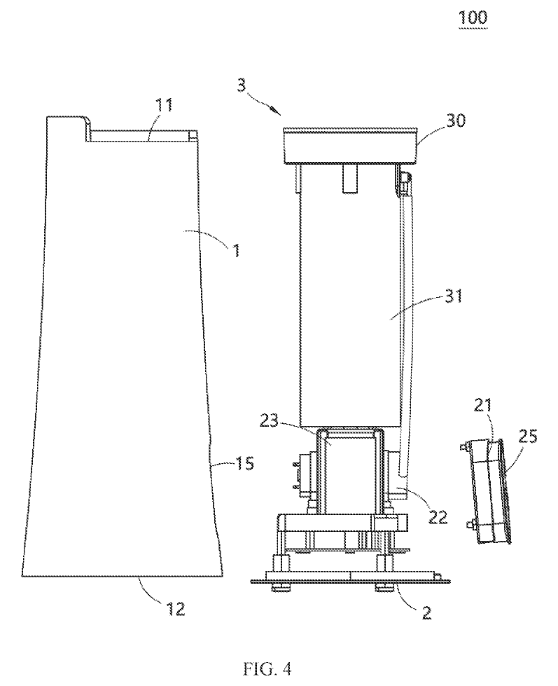

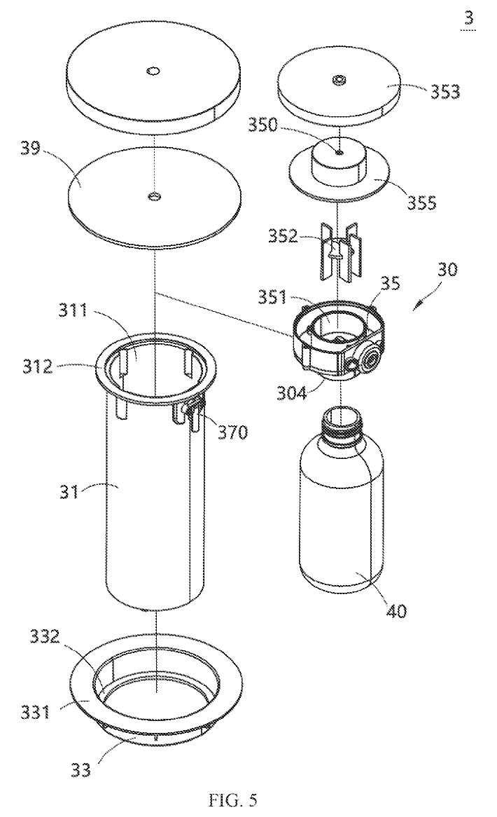

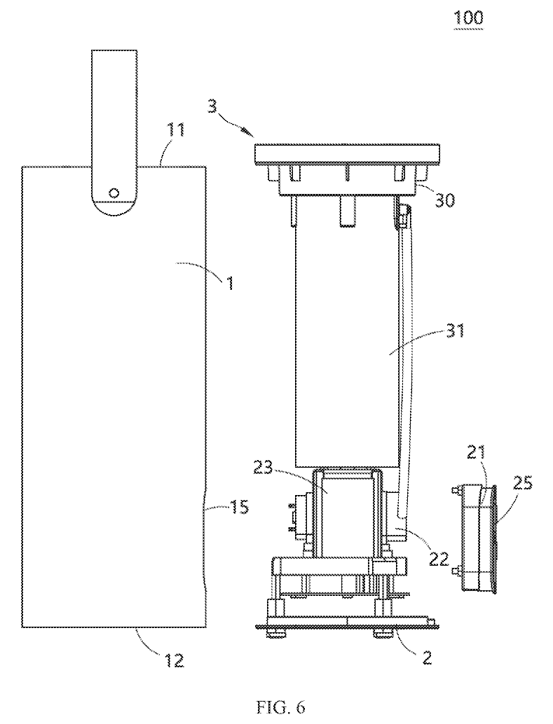

To facilitate understanding of the content of the present disclosure and the effects that can be achieved, specific embodiments are listed with reference to the drawings and described in detail as follows. Referring to FIGS. 1 to 6, the present disclosure provides a multi-universal atomization and diffusion module 100 with quick-replaceable shell, including a styling shell 1, a base 2 and a spray assembly 3.

The styling shell 1 is in the shape of a hollow cylinder, with coupling holes 11 and 12 respectively configured on a top and a bottom of the styling shell 1, and a window 15 is configured on the styling shell.

The base 2 is configured to assemble with the coupling hole 12 located at the bottom of the styling shell 1. The base 2 is configured with at least a circuit board 21, a motor pump 22 and a rechargeable battery 23, which connect to a control panel 25 disposed in the window 15.

The spray assembly 3 is composed of an atomization and diffusion head 30, an assembling bottle 40 and a bottom sleeve 31, which are connected with each other, wherein a movable coupling mechanism 32 is arranged between the bottom sleeve 31 and the base 2, so as to mutually align with each other.

An internal thread port 304 is configured at a bottom of the atomization and diffusion head 30, allowing for replacing and assembling with a plurality of bottle mouth adapters 34. Each bottle adapter 34 has an external thread port 341 configured at a top with a corresponding same diameter and an internal thread port 342 with a different diameter is arranged at a bottom, so as to be connected with the assembling bottles 40 having different sizes and specifications. The assembling bottle 40 may be an essential oil bottle, having a single diameter of 18 mm, available on the market, or other perfume bottles having different diameters, such as 20 mm or 24 mm, but the present disclosure is not limited thereto.

In one preferable embodiment, the movable coupling mechanism 32 is composed of a locking protrusion 321 arranged at a bottom of the bottom sleeve 31 and a corresponding inserting hole 320 arranged on the base 2.

In one preferable embodiment, the spray assembly 3 is a multi-piece stacked assembly, including the movable and detachable atomization and diffusion head 30. The atomization and diffusion head 30 aligns with and sleeves in an opening 311 of the bottom sleeve 31. The bottom sleeve 31 is sleeved in an outer frame ring 33, and a nozzle outer cover 39 is arranged on a top of the outer frame ring 33 to cover the nozzle.

In one preferable embodiment, the outer frame ring 33 is in a downward convex shape, and a peripheral lip 331 is configured on an upper flat opening of the outer frame ring 33, and the nozzle outer cover 39 is designed to be disc-shaped and covers the diameter surface. A peripheral lip 332 is arranged in an inner port of the outer frame ring 33, and the opening 311 of the bottom sleeve 31 is configured with a corresponding peripheral lip 312, which is configured to lean on the peripheral lip 332.

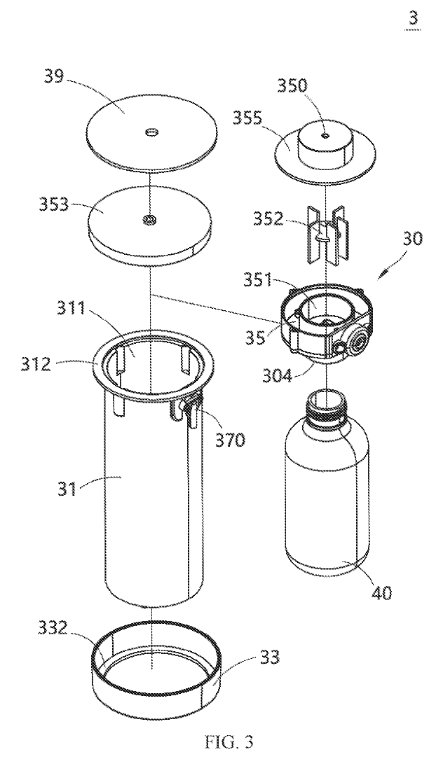

Such that, as shown in FIGS. 3 to 6, the internal structure of the present disclosure adopts a vertical stacking design, and the appearance of the product assembly is changed from horizontal to vertical, thereby occupying a smaller area and being more convenient to adapt to various spatial terrains and interior decoration planning. The newly created module has a quick shell replacement function. Regardless of use or manufacturing, the styling shell 1 can be simply replaced to easily change the appearance of the product, thereby increasing the diversity of the product and the convenience of manufacturing.

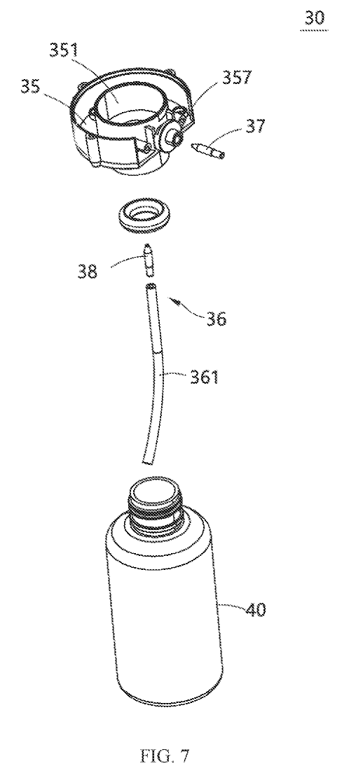

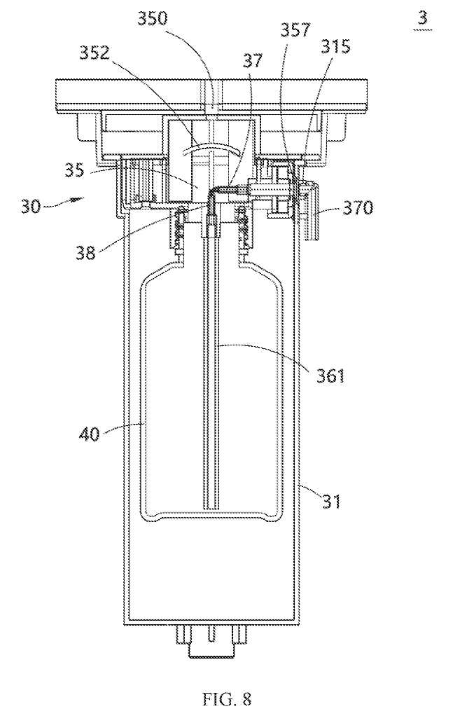

In one preferable embodiment, as shown in FIGS. 7 and 8, an atomizing chamber 35 is configured on a top of the atomization and diffusion head 30, and a fog outlet 350 is configured at a middle of the atomizing chamber 35. A siphon atomizing structure 36 is configured at the bottom of the atomization and diffusion head 30. A side of the atomization and diffusion head 30 internally connects to an air inlet head 37 through an air inlet 357 to communicate with the siphon atomizing structure 36. The siphon atomizing structure 36 includes a siphon tube 361 passing through the atomizing chamber 35. One end of the siphon tube 361 is inserted into the assembling bottle 40, and the other end is located in the atomizing chamber 35 and has an atomizing head 38. The angle between the atomizing head 38 and the air inlet head 37 is less than 90°, and the bottom sleeve 31, corresponding to the air inlet 357, on the side of the atomization and diffusion head 30 is configured with a side sleeve hole 315, which is in a shape of an inverted L and connects to the motor pump 22 through a joint plug-in element 370.

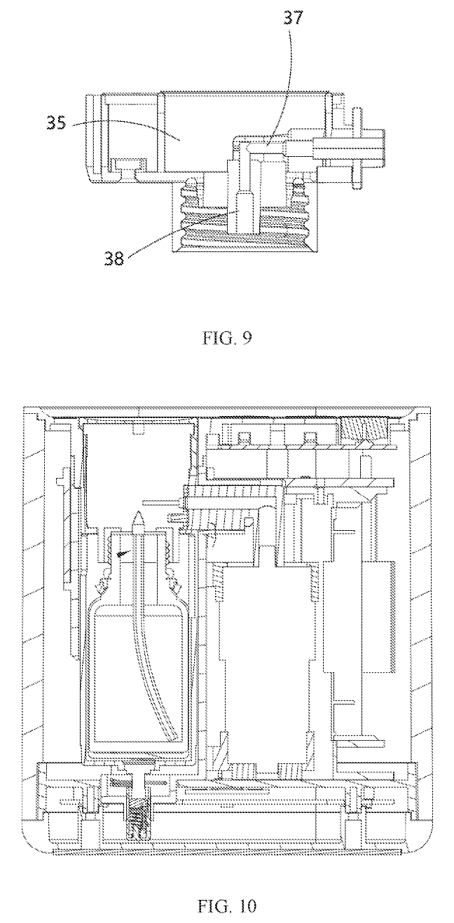

In one preferable embodiment, as shown in FIG. 7, the atomizing head 38 and the air inlet head 37 can be further configured as nozzle elements of the same shape. Each of the nozzle element has a reduced diameter inserting tube arranged at a rear and a nozzle arranged at a front. Airflow baffles, which are spaced apart, are configured on the inner diameter of the nozzle, and a multi-stage airflow channel is arranged in the nozzle element. Or, as shown in FIG. 9, the atomizing head 38 and the air inlet head 37 may also be integrally formed and configured with a L-shaped cover outside.

In one preferable embodiment, the atomizing chamber 35 is concave and has a partition wall 351 in the middle, which divides the atomizing chamber 35 into an inner concave space and an outer concave space. A fog blocking element 352 is movably connected to the inner concave space to prevent the essential oil with large particles from splashing. A convex cap hole cover 355 is arranged on the outer concave space to cover the corresponding diameter surface of the outer concave space. A nozzle inner cover 353, having an outer diameter matches the inner diameter of the outer frame ring 33, is arranged between the nozzle outer cover 39 and the convex cap hole cover 355. Such that, the atomization and diffusion head 30 can be effectively and tightly connected, so as to perform atomizing and diffusing.

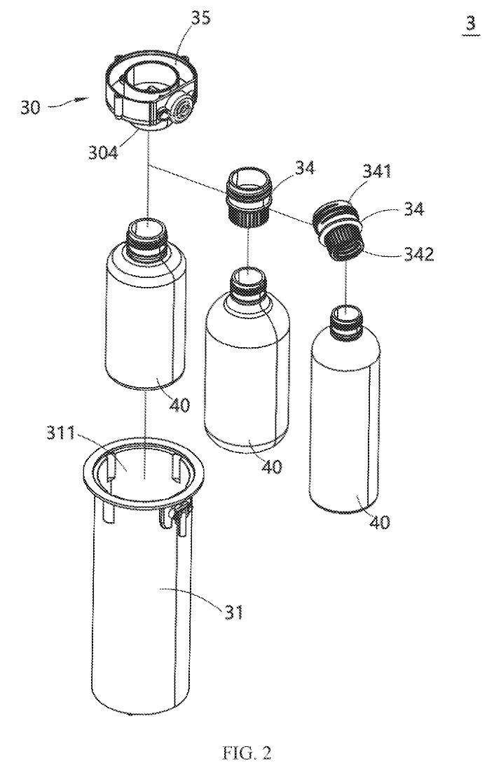

In using, as shown in FIGS. 2 and 8 when the user needs to replace the assembling bottle 40, the user only needs to separate the spray assembly 3 and pull the spray assembly 3 upward to directly replace the assembling bottle 40. The operation is simple and does not require using special tools. Moreover, the key feature of the present disclosure is that the internal thread port 304 is configured at the bottom of the atomization and diffusion head 30, allowing for replacing and assembling with a plurality of bottle mouth adapters 34. Through the external thread port 341 configured at the top of each bottle mouth adapters 3 with a corresponding same diameter and the internal thread port 342 with a different diameter arranged at the bottom of the bottle adapter 3, the assembling bottles 40 having different sizes are allowed to be connected. Such that, by providing multiple types of bottle mouth adapter 34, the present disclosure can be compatible with assembling bottles 40 of various specifications at the same time, whether it is ordinary essential oil bottles or other perfume bottles with different diameters, thereby significantly increasing the compatibility and market application scope of the product.

Such that, the users can conveniently select the assembling bottles 40 of different brands and models without worrying about whether they can be compatible with the equipment, thereby improving the flexibility of use. The commonly seen assembling bottles 40 on the market include essential oil bottles and perfume bottles with different diameters. The specifications and sizes of the bottles are different from brand to brand. However, the effective multiple bottle mouth adapters 34 of the present disclosure can be widely used, ensuring that the users can easily match the assembling bottles 40 with suitable bottle mouths in home, commercial or professional environments. This creation can be applied to a wider range of market demands, including beauty salons, SPAs, hotels, restaurants and other places. The atmosphere and the selected essential oil of each place can be flexibly adjusted to provide a customized fragrance experience. Therefore, it not only improves consumers' satisfaction with use, but also expands the competitiveness of the fragrance and health products market, making the products more market-appealing and with greater sales potential.

In summary, this invention is novel, practical and fully meets the patent requirements, so an application for a new patent is filed. However, what is described above is only a preferred embodiment of the present invention and should not be used to limit the scope of implementation of the present invention. Therefore, all equivalent changes and modifications made according to the scope of the patent application of the present invention and the content of the disclosure specification should fall within the scope covered by the patent of the present invention.

What is claimed is:

1. A multi-universal automation and diffusion module with quick-replaceable shell, comprising:
a styling shell, wherein the styling shell is a shape of a hollow cylinder with coupling holes respectively configured on a top and a bottom, and a window is configured on the styling shell;
a base, wherein the base is configured to assemble with the coupling hole located at the bottom of the styling shell, the base is configured with at least a circuit board, a motor pump and a rechargeable battery, which connect to a control panel disposed in the window;
a spray assembly, wherein the spray assembly is composed of an atomization and diffusion head, an assembling bottle and a bottom sleeve, which are connected with each other, a movable coupling mechanism is arranged between the bottom sleeve and the base, so as to mutually align with each other, the movable coupling mechanism is composed of a locking protrusion arranged at a bottom of the bottom sleeve and a corresponding inserting hole arranged on the base;
wherein the spray assembly is a multi-piece stacked assembly and comprises the movable and detachable atomization and diffusion head, the atomization and diffusion head aligns with and sleeves in an opening of the bottom sleeve, the bottom sleeve is sleeved in an outer frame ring, and a nozzle outer cover is arranged on a top of the outer frame ring to cover the nozzle;
wherein an atomizing chamber is configured on a top of the atomization and diffusion head, and a fog outlet is configured at a middle of the atomizing chamber, a siphon atomizing structure is configured at the bottom of the atomization and diffusion head, a side of the atomization and diffusion head internally connects to an air inlet head through an air inlet to communicate with the siphon atomizing structure, the siphon atomizing structure comprises a siphon tube passing through the atomizing chamber, one end of the siphon tube is inserted into the assembling bottle, and the other end is located in the atomizing chamber and has an atomizing head, an angle between the atomizing head and the air inlet head is less than 90°, and the bottom sleeve, corresponding to the air inlet, on the side of the atomization and diffusion head is configured with a side sleeve hole, which is in a shape of an inverted L and connects to the motor pump through a joint plug-in element;
wherein an internal thread port is configured at a bottom of the atomization and diffusion head, allowing for replacing and assembling with a plurality of bottle mouth adapters, each bottle adapter has an external thread port configured at a top with a corresponding same diameter and an internal thread port with a different diameter is arranged at a bottom, so as to be connected with the assembling bottles having different sizes and specifications, and the assembling bottles comprises essential oil bottles and perfume bottles.

2. The multi-universal automation and diffusion module with quick-replaceable shell according to claim 1, wherein the atomizing head and the air inlet head are configured as nozzle elements of the same shape, each of the nozzle element has a reduced diameter inserting tube arranged at a rear and a nozzle arranged at a front, airflow baffles, which are spaced apart, are configured on an inner diameter of the nozzle, and a multi-stage airflow channel is arranged in the nozzle element.

3. The multi-universal automation and diffusion module with quick-replaceable shell according to claim 1, wherein the atomizing head and the air inlet head are integrally formed and configured with a L-shaped cover outside.

4. The multi-universal automation and diffusion module with quick-replaceable shell according to claim 1, wherein the atomizing chamber is concave and has a partition wall in a middle, which divides the atomizing chamber into an inner concave space and an outer concave space, a fog blocking element is movably connected to the inner concave space to prevent the essential oil with large particles from splashing, a convex cap hole cover is arranged on the outer concave space to cover a corresponding diameter surface of the outer concave space, a nozzle inner cover, having an outer diameter matches the inner diameter of the outer frame ring, is arranged between the nozzle outer cover and the convex cap hole cover, making the atomization and diffusion head being effectively and tightly connected, so as to perform atomizing and diffusing.

5. The multi-universal automation and diffusion module with quick-replaceable shell according to claim 1, wherein the outer frame ring is in a downward convex shape, and a first peripheral lip is configured on an upper flat opening of the outer frame ring, and the nozzle outer cover is disc-shaped and cover the diameter surface, a second peripheral lip is arranged in an inner port of the outer frame ring, and the opening of the bottom sleeve is configured with a corresponding third peripheral lip, which is configured to lean on the second peripheral lip.
